(19) United States
(12) Patent Application Publication
(10) Pub. No.: US 2004/0070826 A1
(43) Pub. Date: Apr. 15, 2004

(54) Polarizing interference microscope

(75) Inventor: Ralf Krueger, Butzbach/Griedel (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Wetzlar GmbH, Wetzlar (DE)

(21) Appl. No.: 10/681,921

(22) Filed: Oct. 9, 2003

(30) Foreign Application Priority Data
Oct. 10, 2002 (DE) DE 102 47 248.3

(51) Int. Cl. G02B 5/30; G02B 27/28

(52) U.S. Cl. 359/483

(57) ABSTRACT

In a polarizing interference microscope includes a light source, a polarizer, and an analyzer. An objective prism is arranged between the polarizer and analyzer. A birefringent compensation element is furthermore arranged in the immediate vicinity of the objective prism. A liquid crystal matrix element can be provided as the birefringent compensation element.

Priority is claimed to German patent application 102 47 248.3, the subject matter of which is hereby incorporated by reference herein. Furthermore, all references cited herein are hereby incorporated by reference herein.

The invention concerns a polarizing interference microscope having a light source, a polarizer, an analyzer, and an objective prism that is arranged between the polarizer and analyzer.

### BACKGROUND

Microscopes of various kinds that are suitable for the particular intended application are used for the microscopic examination of specimens. Microscopes using the method of differential interference contrast can be used for the examination of unstained transparent specimens in transmitted light. The principle of such microscopes is that topographical differences in the specimen are visualized by the fact that a plane wave is phase-modulated by the specimen structure. That modulated wave can then be caused to interfere with an uninfluenced reference beam. The pattern thereby obtained allows a quantitative determination of path differences in the specimen. With this method, the path differences can also be converted into a relief image or a color-contrasted image.

In addition to the possibility of forming an image from the interference between the modulated wave and an uninfluenced reference beam, the possibility also exists of generating an image using so-called differential interference contrast (DIC). Topographical differences and material-dependent phase changes at the surface of the specimen can be visualized in high-contrast fashion with this method. Unlike in the interference contrast method, in the differential interference contrast method the modulated wave is made to interfere not with an uninfluenced reference beam, but with the laterally offset phase-modulated object wave itself. In the differential interference contrast method, the differential values at adjacent specimen points therefore participate in the generation of the image. The only specimen details made visible are therefore those that are in the immediate vicinity of a refractive index gradient or thickness gradient that can be sufficiently visualized by an interference of adjacent waves.

A microscope that uses the aforementioned differential interference contrast method is known, for example, from German patent document DE 24 01 973 and from U.S. Pat. No. 2,601,175. Here linearly polarized light is split by a condenser prism into two sub-beams that are polarized perpendicularly to one another and offset parallel to each other. The two sub-beams accordingly pass through the specimen at different points, and are combined again using an objective prism arranged after the specimen. An analyzer arranged farther along in the beam path causes the two sub-beams to interfere. Differences in optical path length, which are attributable to topographical differences or material-dependent phase changes, can thereby be converted into intensity differences. Those intensity differences can then be used to produce a sharp image of the specimen.

In principle, this method can be implemented even without the condenser prism. The condenser prism is necessary, however, in order to produce a high-contrast image; the condenser prism acts as a so-called compensation prism, which can compensate for path differences in the objective prism resulting from the two prism parts.

It is already known from U.S. Pat. No. 3,563,629 that the use of polarized light in this imaging method creates difficulties which can be resolved only by making the illumination aperture considerably smaller. When a microscope of this kind is used, a corresponding prism must accordingly be developed for each pupil location; this results in high costs for manufacturing such microscopes.

FIG. 1 schematically depicts the beam path of an interference polarizing microscope according to the existing art. A light beam 12 is generated by a light source 10 and is guided through a polarizer 14. Light beam 13 emerging from polarizer 14 is then linearly polarized, and is split by a condenser prism 16 into two sub-beams 15, 17 polarized perpendicularly to one another. The two sub-beams 15, 17, offset parallel to one another, travel through a condenser 18 onto a specimen 20. In specimen 20, each of sub-beams 15, 17 is individually modulated in accordance with the particular local specimen properties that are present.

Sub-beams 15, 17 that are offset parallel to one another are subsequently combined by objective 22, and then pass through objective prism 24. Analyzer 26 arranged behind objective prism 24 causes the two sub-beams to interfere once again. Differences in the optical path lengths caused by interaction with specimen 20 are thereby converted into intensity differences.

In principle, this differential interference contrast process already known from the existing art functions even without condenser prism 16. The condenser aperture must then, however, be configured in the form of a narrow slit. As a result, the desired contrast effect can be achieved only by the use of objective prism 24. This, however, limits the aperture. In order to be able to generate a high-contrast image, it is therefore necessary to use condenser prism 16, called a “compensation prism,” on the condenser side as well, since that is the only way to compensate for the path differences in objective prism 24 resulting from the two prism wedges. Objective prism 24 can therefore also be referred to as the “main prism,” and condenser prism 16 as the “compensation prism.”

The circumstances upon passage of a linearly polarized light beam 13 through prism 21, which for example can be a main prism or a compensation prism, are depicted in FIGS. 2a and 2b. In FIG. 2a, linearly polarized light beam 13 passes through the center of prism 21. The incoming light beam 13 is split at the cemented wedge surface 23. Because the wedge thicknesses are identical, the two sub-beams 15, 17 exhibit no path difference after the prism. This is illustrated in the sketch by the two horizontal lines 25 and 27, which in this case lie in the same plane.

FIG. 2b illustrates the situation for two linearly polarized beams 13, 13′ that strike prism 21 off-center. Beam 13 once again strikes wedge surface 23. Because the thickness of the two wedges of prism 21 is different, however, a positive path difference occurs between sub-beams 15 and 17, as indicated again by lines 25 and 27. For linearly polarized light beam 13′ arriving on the opposite side of prism 21, a negative path difference correspondingly occurs between the two sub-beams 15′ and 17′, as indicated by lines 27′ and 25′. It is therefore usually necessary to compensate for these path differences by using a second prism.

### SUMMARY OF THE INVENTION

It is therefore an object of the present invention to provide a polarizing interference microscope that can be used irrespective of the pupil location.

The present invention provides a polarizing interference microscope comprising:

a light source (10),

a polarizer (14),

an analyzer (26),

an objective prism (24) being arranged between said polarizer (14) and said analyzer (26), and

a birefringent compensation element (28) which is arranged between the polarizer (14) and analyzer (26).

According to the invention, a birefringent element is inserted between crossed polarizers and compensates for the optical path length differences in the sub-beams over the diameter of the objective prism.

This compensation element can be introduced both in microscopes that operate in transmitted light and in microscopes that use the incident-light method. A particular advantage in the context of transmitted-light microscopes is that the pupil location of the objective no longer influences the image quality. The use of the birefringent compensation element thus makes available a microscope that ensures good image quality regardless of the pupil location. Even objectives that have large pupil aberrations, for example in the hyperopic region, can therefore be used. In addition, the condenser prism on the condenser side can be entirely dispensed with.

For incident-light microscopes as well, the advantage of using the birefringent compensation element consists in the fact that it can now be used irrespective of the pupil location. Discrimination of first-order reflections is also better.

### BRIEF DESCRIPTION OF THE DRAWINGS

The invention is elaborated upon below based on exemplary embodiments, with reference to the drawings, in which accurately scaled depiction was dispensed with in the interest of clarity.

In the drawings:

FIG. 1 shows the beam path within a transmitted-light polarizing interference microscope using differential interference contrast according to the existing art;

FIGS. 2a, b illustrate the conditions that exist upon passage of a light beam through a prism according to the existing art;

FIG. 3 shows the beam path through a polarizing interference microscope according to the present invention in transmitted light; and

FIG. 4 shows the beam path through a polarizing interference microscope according to the present invention in incident light.

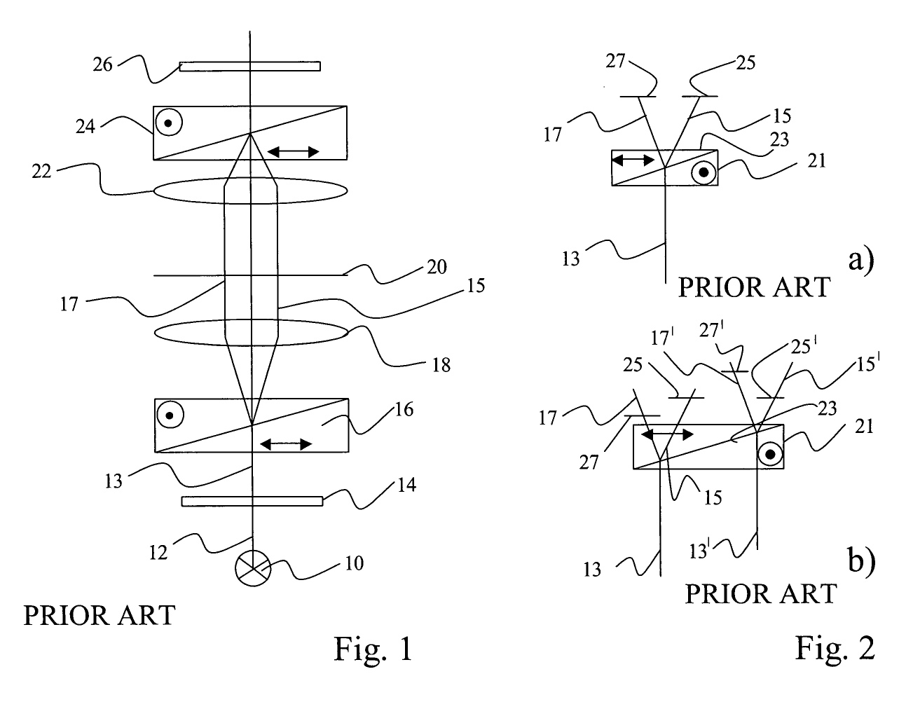

### DETAILED DESCRIPTION

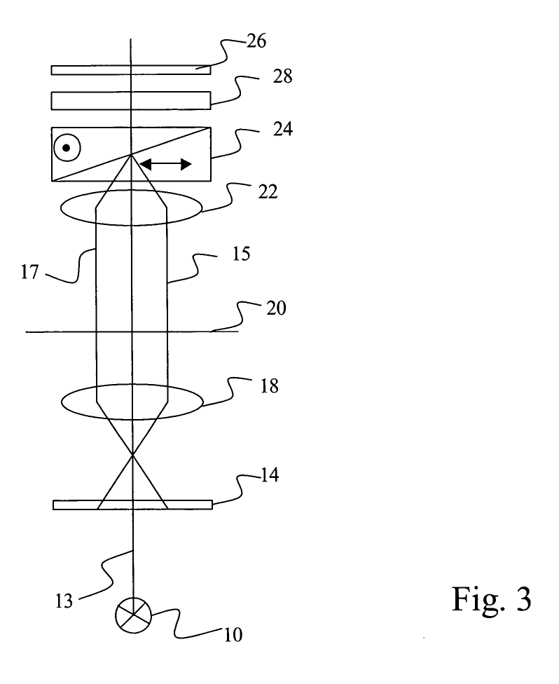

To eliminate the need to use a second prism (the so-called compensation prism), according to the present invention an additional birefringent compensation element 28 is provided in the beam path. One example of such an arrangement is shown in FIG. 3, where a birefringent compensation element 28 is introduced between the crossed polarizers 14, 26. Birefringent compensation element 28 is capable of compensating for the optical path length differences of sub-beams 15, 17 over the entire diameter of prism 24. A liquid crystal matrix element (LCD) is preferably used for this purpose. For enhanced functionality, compensation element 28 may be arranged in the immediate vicinity of objective prism 24. In the embodiment of the invention shown in FIG. 3, birefringent compensation element 28 is inserted between analyzer 26 and objective prism 24. Alternatively, it is also possible to use birefringent compensation element 28 between objective prism 24 and objective 22.

With the use of birefringent compensation element 28, the arrangement in transmitted light is independent of the pupil location of the objectives, so that it is no longer necessary to develop a corresponding prism for each pupil location. Even objectives that exhibit large pupil aberrations, which typically occur in the hyperopic region, can therefore be used. It is accordingly also no longer necessary to provide a compensation prism on the condenser side for each magnification range.

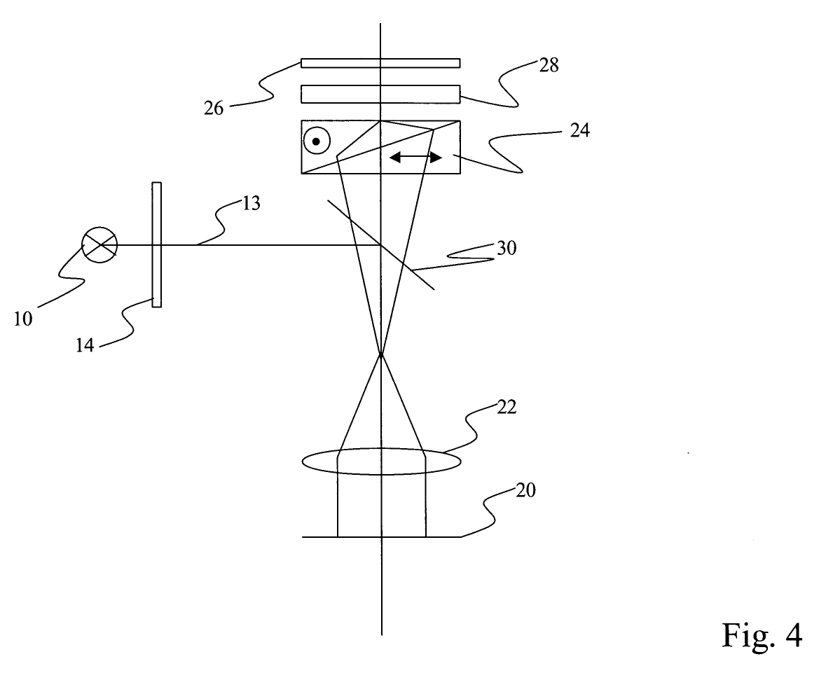

According to the present invention, birefringent compensation element 28 can also be used in a microscope that operates in incident-light mode. An example thereof is depicted schematically in FIG. 4. Light beam 13 coming from a light source 10 is linearly polarized in a polarizer 14, and guided by a semitransparent mirror 30 through objective 22 and onto specimen 20. The radiation reflected therefrom passes through semitransparent mirror 30 and travels via objective prism 24 to analyzer 26. A birefringent compensation element 28, which compensates for the optical path length differences between the sub-beams over the diameter of the prism, is once again arranged between analyzer 26 and objective prism 24. Once again, a liquid crystal matrix element is preferably used in this context. The birefringent compensation element makes the arrangement independent of pupil location, and furthermore offers better discrimination of first-order reflections.

### PARTS LIST

10 Light source

12 Light beam

13 Polarized light beam

14 Polarizer

15 Sub-beam

16 Condenser prism

17 Sub-beam

18 Condenser

20 Specimen

21 Prism

22 Objective

23 Wedge surface

24 Objective prism

25 Line

26 Analyzer

27 Line

28 Birefringent compensation element

30 Semitransparent mirror

What is claimed is:

1. A polarizing interference microscope comprising:
a light source;
a polarizer;
an analyzer;
an objective prism disposed between the polarizer and the analyzer; and
a birefringent compensation element disposed between the polarizer and analyzer.

2. The polarizing interference microscope as recited in claim 1 wherein the polarizing interference microscope includes a transmitted-light microscope.

3. The polarizing interference microscope as recited in claim 1 further comprising a semitransparent mirror and wherein the polarizing interference microscope includes an incident-light microscope.

4. The polarizing interference microscope as recited in claim 1 wherein the birefringent compensation element is disposed in an immediate vicinity of the objective prism.

5. The polarizing interference microscope as recited in claim 2 wherein the birefringent compensation element is disposed between the analyzer and the objective prism.

6. The polarizing interference microscope as recited in claim 2 further comprising an objective and wherein the birefringent compensation element is disposed between the objective prism and the objective.

7. The polarizing interference microscope as recited in claim 1 wherein the birefringent compensation element includes a liquid crystal matrix element.

8. The polarizing interference microscope as recited in claim 2 wherein the birefringent compensation element includes a liquid crystal matrix element.

9. The polarizing interference microscope as recited in claim 3 wherein the birefringent compensation element includes a liquid crystal matrix element.

10. The polarizing interference microscope as recited in claim 4 wherein the birefringent compensation element includes a liquid crystal matrix element.

11. The polarizing interference microscope as recited in claim 5 wherein the birefringent compensation element includes a liquid crystal matrix element.

12. The polarizing interference microscope as recited in claim 6 wherein the birefringent compensation element includes a liquid crystal matrix element.
